(19) United States
(12) Patent Application Publication
(10) Pub. No.: US 2023/0373530 A1
(43) Pub. Date: Nov. 23, 2023

(54) VEHICLE CONTROL DEVICE AND VEHICLE CONTROL METHOD

(71) Applicant: DENSO CORPORATION, Kariya-city (JP)

(72) Inventors: Takuya KUME, Kariya-city (JP); Kazuki IZUMI, Kariya-city (JP)

(21) Appl. No.: 18/363,603

(22) Filed: Aug. 1, 2023

Related U.S. Application Data
(63) Continuation of application No. PCT/JP2022/009795, filed on Mar. 7, 2022.

(30) Foreign Application Priority Data
Mar. 22, 2021 (JP) 2021-047522

(51) Int. Cl. B60W 60/00; B60W 50/14; B60W 30/18; B60Q 1/08

(52) U.S. Cl. CPC B60W 60/0018; B60W 60/0053; B60W 50/14; B60W 30/18163; B60Q 1/085; B60W 2556/10; B60W 2556/45; B60W 2540/225; B60W 2555/20

(57) ABSTRACT

A vehicle control technique is used for execution of an automated driving of a vehicle. The automated driving is a control for autonomously driving the vehicle based on an output signal of an outside-monitoring sensor. In the vehicle control technique, it is predicted whether a detection capability of the outside-monitoring sensor falls below a required level within a prediction time period from a current time based on a history of the output signal of the outside-monitoring sensor or dynamic map data related to a road section through which the vehicle is scheduled to pass. The required level corresponds to a performance quality of the outside-monitoring sensor required to continue the automated driving. A predetermined temporary control is started during the automated driving based on a fact that the detection capability is predicted to fall below the required level within the prediction time period.

### CROSS REFERENCE TO RELATED APPLICATIONS

The present application is a continuation application of International Patent Application No. PCT/JP2022/009795 filed on Mar. 7, 2022, which designated the U.S. and claims the benefit of priority from Japanese Patent Application No. 2021-047522, filed on Mar. 22, 2021. The entire disclosures of all of the above applications are incorporated herein by reference.

### TECHNICAL FIELD

The present disclosure relates to a vehicle control device and a vehicle control method for performing automated driving.

### BACKGROUND

A vehicle control device starts an automated driving of a vehicle when the vehicle is caught in a traffic jam having a length longer than a predetermined value.

### SUMMARY

According to at least one embodiment of the present disclosure, a vehicle control device is configured to execute an automated driving of a vehicle. The automated driving is a control for autonomously driving the vehicle based on an output signal of an outside-monitoring sensor that detects an object existing around the vehicle. The vehicle control device includes a processor configured to predict whether a detection capability of the outside-monitoring sensor falls below a required level within a prediction time period based on a history of the output signal of the outside-monitoring sensor or dynamic map data related to a road section through which the vehicle is scheduled to pass. The required level corresponds to a performance quality of the outside-monitoring sensor required to continue the automated driving. The prediction time period is a predetermined time period from a current time. The history of the output signal is a history for a predetermined time period immediately before the current time. The dynamic map data is data acquired via a wireless communication from an external device. The processor is configured to start a predetermined temporary control during the automated driving based on a fact that the detection capability is predicted to fall below the required level within the prediction time period.

According to at least one embodiment of the present disclosure, a vehicle control method is a method for a vehicle configured to execute an automated driving based on an output signal of an outside-monitoring sensor. The outside-monitoring sensor detects an object existing around the vehicle. The vehicle control method is executed by at least one processor. The vehicle control method includes predicting whether a detection capability of the outside-monitoring sensor falls below a required level within a prediction time period based on a history of the output signal of the outside-monitoring sensor or dynamic map data related to a road section through which the vehicle is scheduled to pass. The required level corresponds to a performance quality of the outside-monitoring sensor required to continue the automated driving. The prediction time period is a predetermined time period from a current time. The history of the output signal is a history for a predetermined time period immediately before the current time. The dynamic map data is data acquired via a wireless communication from an external device. The vehicle control method includes starting a predetermined temporary control during the automated driving based on a fact that the detection capability is predicted to fall below the required level within the prediction time period.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a block diagram showing an example of an overall configuration of an automated driving system.

FIG. 2 is a block diagram for explaining a configuration of a front camera.

FIG. 3 is a block diagram illustrating an example of a notification device.

FIG. 4 is a functional block diagram of an automated driving ECU.

FIG. 5 is a flowchart for explaining an operation of the automated driving ECU.

### DETAILED DESCRIPTIONS

To begin with, examples of relevant techniques will be described. According to a comparative example, a vehicle control device starts an automated driving of a vehicle when the vehicle is caught in a traffic jam having a length longer than a predetermined value. In another comparative example, an area where a detection capability of an outside-monitoring sensor such as a camera is deteriorated is identified based on reports from multiple vehicles and information on the area is distributed. Then, automated driving is terminated based on a fact that a current position of the vehicle is in the area.

There can be multiple automation levels of driving operations, as defined by the Society of Automotive Engineers of America (SAE International), for example. Automated driving in the present disclosure means a level at which the system performs all driving tasks, and the user does not need to monitor the surroundings of the vehicle (mainly ahead of the vehicle). The automated driving is equivalent to so-called level 3 or higher. Automation levels 0, 1, and 2 correspond to levels at which the user is required to monitor the surroundings of the vehicle. The system here is an in-vehicle system including the vehicle control device that provides an automated driving function. The user here is an occupant sitting in the driver's seat. While the system is performing the automated driving, the user is not required to look ahead of the vehicle and the user may be allowed to perform a predetermined action as a second task, such as operating a smartphone.

The system performing the automated driving recognizes the surroundings based on sensing information from the outside-monitoring sensor such as the camera, and creates a control plan. Therefore, when a detection performance of the outside-monitoring sensor falls below a predetermined required level for continuing the automated driving due to, for example, dense fog or yellow dust, the automated driving may be interrupted. In addition, when a recognition rate of a lane marking that defines lanes declines due to blurring of lines, puddles, etc., an accuracy of estimating a position of the vehicle can decrease, thereby the automated driving being interrupted.

When the automated driving is frequently interrupted, the user may be required to repeatedly suspend the second task. As the result, the user convenience may be reduced.

In contrast to the comparative example, according to the present disclosure, a possibility of interruption of the automated driving can be reduced.

According to an aspect of the present disclosure, a vehicle control device is configured to execute an automated driving of a vehicle. The automated driving is a control for autonomously driving the vehicle based on an output signal of an outside-monitoring sensor that detects an object existing around the vehicle. The vehicle control device includes a detection capability prediction unit and a temporary control unit. The detection capability prediction unit is configured to predict whether a detection capability of the outside-monitoring sensor falls below a required level within a prediction time period based on a history of the output signal of the outside-monitoring sensor or dynamic map data related to a road section through which the vehicle is scheduled to pass. The required level corresponds to a performance quality of the outside-monitoring sensor required to continue the automated driving. The prediction time period is a predetermined time period from a current time. The history of the output signal is a history for a predetermined time period immediately before the current time. The dynamic map data is data acquired via a wireless communication from an external device. The temporary control unit is configured to start a predetermined temporary control during the automated driving based on a fact that the detection capability is predicted to fall below the required level within the prediction time period.

According to an aspect of the present disclosure, a vehicle control method is a method for a vehicle configured to execute an automated driving based on an output signal of an outside-monitoring sensor. The outside-monitoring sensor detects an object existing around the vehicle. The vehicle control method is executed by at least one processor. The vehicle control method includes predicting whether a detection capability of the outside-monitoring sensor falls below a required level within a prediction time period based on a history of the output signal of the outside-monitoring sensor or dynamic map data related to a road section through which the vehicle is scheduled to pass. The required level corresponds to a performance quality of the outside-monitoring sensor required to continue the automated driving. The prediction time period is a predetermined time period from a current time. The history of the output signal is a history for a predetermined time period immediately before the current time. The dynamic map data is data acquired via a wireless communication from an external device. The vehicle control method further includes starting a predetermined temporary control during the automated driving based on a fact that the detection capability is predicted to fall below the required level within the prediction time period.

According to the vehicle control device/method described above, when the detection capability of the outside-monitoring sensor is likely to fall below the required level, the temporary control is started in advance. This can be expected to prevent the detection capability of the outside-monitoring sensor from falling below the required level, or to extend a remaining time until the detection capability actually falls below the required level. As a result, the possibility of interruption of the automated driving can be reduced.

Hereinafter, an embodiment of the present disclosure will be described with reference to the drawings. The present disclosure can be appropriately modified and implemented to conform to the laws, regulations, and conventions of an area where the vehicle control device is used.

<Introduction>

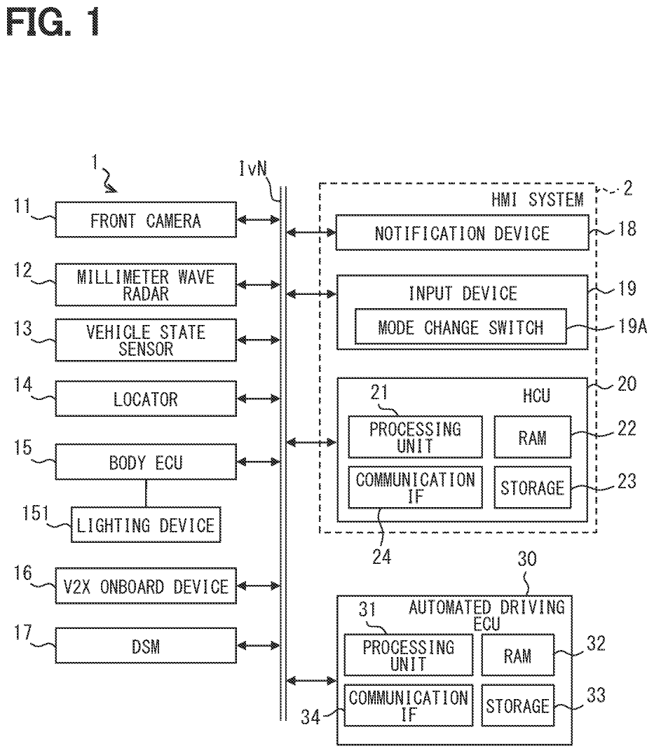

FIG. 1 is a diagram showing an example of a schematic configuration of the automated driving system 1 according to the present disclosure. The automated driving system 1 may be mounted on a vehicle that can travel on roads. The vehicle on which the automated driving system 1 is mounted may be a four-wheel automobile, a two-wheel automobile, a three-wheel automobile, or the like. The vehicle on which the automated driving system 1 is mounted may be an owner car, a shared car, a rental car, or a transportation service car. The owner car is a car owned by an individual. The transportation service car includes a taxi, a route bus, a community bus, and the like. The shared car is a vehicle provided for a car sharing service. A rental car is a vehicle provided for a vehicle rental service. Hereafter, the vehicle on which the automated driving system 1 is mounted is also described as a subject vehicle.

Here, as an example, the subject vehicle is an electric vehicle, but the subject vehicle is not limited to the electric vehicle. The subject vehicle may be an engine vehicle, or a hybrid vehicle. The electric vehicle is a vehicle that has only a motor as a drive source. The engine vehicle is a vehicle that has only an engine as the drive source. The engine vehicle corresponds to a vehicle that runs on fuel such as gasoline or light oil. The hybrid vehicle is a vehicle that has a motor and an engine as the drive source. In addition, the subject vehicle may be a fuel cell vehicle (FCV).

In the following description, an example in which the automated driving system 1 is used in a left-hand traffic country/area will be described. Under left-hand traffic, a leftmost lane among the lanes having the same traveling direction on a road is referred to as a first lane. When the automated driving system 1 is used in a right-hand traffic country/area, the configuration of the present disclosure can be implemented by reversing the above-described elements related to right and the elements related to left. For example, in the right-hand traffic area, the first lane indicates a rightmost lane among the lanes having the same traveling direction on the road. The automated driving system 1 described below can be changed to conform to traffic regulations or customs of an area where the automated driving system 1 is used.

A user in the present disclosure is a person who should receive driving operation authority from the automated driving system 1 during automated driving. The term “user” means a person who is sitting in a driver seat, in other words, a driver's seat occupant. The term “user” in the present disclosure may be replaced with a “driver.” The subject vehicle may be a remotely operated vehicle which is remotely operated by an operator outside the subject vehicle. The operator here is a person who has an authority to remotely control the subject vehicle from the outside of the subject vehicle, such as a person in a predetermined operation center. The operator can also be included in the user. An HCU 20, described below, may be configured to present various information to the operator.

The automated driving system 1 provides a so-called automated driving function for autonomously driving the subject vehicle. There can be multiple levels of automation of driving operations (hereinafter referred to as automation levels), as defined by the Society of Automotive Engineers of America (SAE International), for example. According to the SAE definition, for example, the automation levels are categorized into the following six levels.

Level 0 is a level in which the user in driver's seat performs all driving tasks without an involvement of the system. The driving tasks may include a steering operation, acceleration/deceleration operation, and the like. The driving tasks may also include monitoring surroundings of the subject vehicle, such as a front area of the subject vehicle. Level 0 corresponds to a fully manual driving level. Level 1 is a level in which the system assists either the steering operation or the acceleration/deceleration operation. Level 2 is a level in which the system supports multiple operations among the steering operation and the acceleration/deceleration operation. The level 1 and the level 2 correspond to a driving assistance level.

Level 3 is a level in which the system performs all the operation tasks within an operational design domain (ODD), while the operation authority is transferred from the system to the user in an emergency. The ODD defines conditions under which the automated driving can be executed, such as a situation the subject vehicle is traveling on a highway. In the level 3, the user is required to respond quickly when the system requests to take over the driving operation. In addition, instead of the user, the operator existing outside of the subject vehicle may take over the driving operation from the system. The level 3 corresponds to a conditional automated driving.

Level 4 is a level in which the system performs all driving tasks, except under a specific circumstance, such as an unsupported road, an extreme environment, and the like. The Level 4 corresponds to a level in which the system performs all the driving tasks within the ODD. The level 4 corresponds to a highly automated driving. Level 5 is a level in which the system is capable of performing all driving tasks in any situation. The level 5 corresponds to a fully automated driving. The level 3 to the level 5 correspond to the automated driving. The level 3 to the level 5 can also be referred to as an automated driving level that the system automatically executes all controls related to driving of the subject vehicle. A level of automated driving in the present disclosure is a level at which the user does not need to monitor the front. The level of automated driving may be level 3 or higher. Hereinafter, a case in which the automated driving system 1 is configured to being capable of performing automated driving at the level 3 or higher level will be described.

<Configurations of Automated Driving System>

The automated driving system 1 has various configurations shown in FIG. 1 as an example. The automated driving system 1 includes a front camera 11, a millimeter wave radar 12, a vehicle state sensor 13, a locator 14, a body ECU 15, a lighting device 151, a V2X onboard device 16, and a DSM 17. The automated driving system 1 also includes a notification device 18, an input device 19, the HCU 20 and an automated driving ECU 30. A system including the notification device 18, the input device 19, and the HCU 20 is configured as an HMI system 2. The HMI system 2 provides an input interface function for receiving a user operation and an output interface function for presenting information to the user. The term “ECU” used in the above-described component name is an abbreviation for electronic control unit. The DSM is an abbreviation for Driver Status Monitor. The HMI is an abbreviation for human machine interface. The HCU is an abbreviation for HMI control unit. The V2X is an abbreviation for vehicle to x (everything/something) and indicates a communication technology that connects various things to a vehicle.

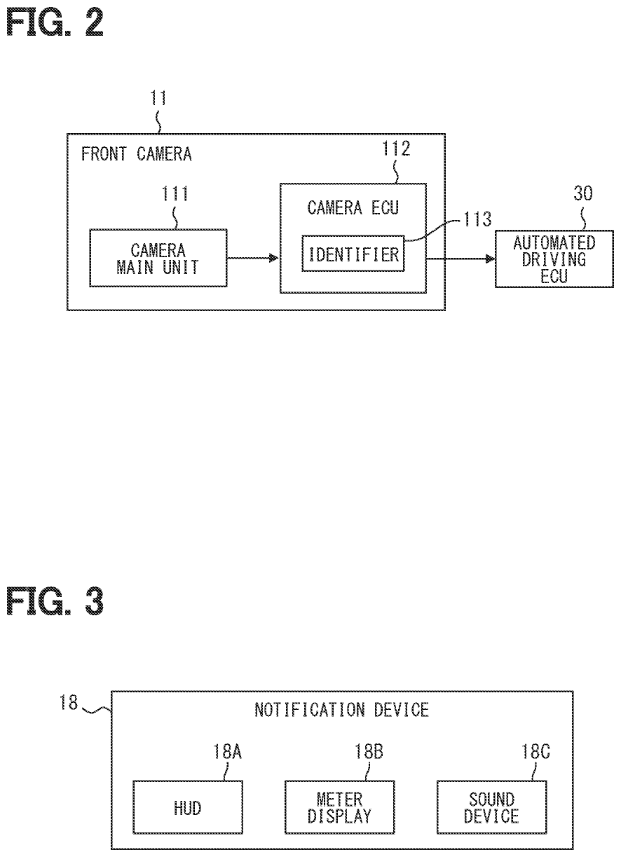

The front camera 11 captures images of a front area of the subject vehicle at a predetermined angle of view. The front camera 11 is disposed, for example, at an upper end portion of a front windshield in a vehicle compartment, a front grille, or a roof top. As shown in FIG. 2, the front camera 11 includes a camera main unit 111 and a camera ECU 112. The camera main unit 111 generates an image frame. The camera ECU 112 is an ECU which detects a predetermined detection target by performing a recognition process on the image frame. The camera main unit 111 at least includes an image sensor and a lens. The camera main unit 111 generates and outputs captured image data at a predetermined frame rate (for example, 60 fps). The camera ECU 112 has an image processing chip including a central processing unit (CPU) or a graphics processing unit (GPU). The camera ECU 112 includes an identifier 113 as a functional block. The identifier 113 is configured to identify a type of an object based on a feature amount vector of the image frame generated by the camera main unit 111. The identifier 113, for example, may be realized with use of a convolutional neural network (CNN) or a deep neural network (DNN), to which deep learning is applied.

The detection target of the front camera 11 may include moving objects, such as pedestrians or other vehicles. The other vehicles include a bicycle, a motorized bicycle, and a motorcycle. In addition, the front camera 11 is configured to be capable of detecting predetermined features. The features to be detected by the front camera 11 include a road edge, a road marking, and a structure arranged along the roadside. The road marking is a marking that is painted on a road surface for traffic control and traffic regulation purpose. For example, the road marking includes a lane division line indicating a lane boundary, a pedestrian crossing, a stop line, a buffer zone, a safety zone, or a regulatory arrow. The lane division line is also referred to as a lane mark or a lane marker. The lane division line may be realized with use of road studs such as chatter bars and botts' dots. In the following description, the term “lane marking” indicates a boundary line between lanes. The lane marking includes a roadway outer line, a center line, or the like.

The structure arranged along the roadside may include guard rails, curbs, trees, electric poles, traffic signs, or traffic lights. The image processing chip of the camera ECU 112 separates and extracts a background and the detection target object from the captured image based on image information including color, brightness, and contrast related to color/brightness. The front camera 11 may be configured to be capable of detecting features that can be used as landmarks in a localization process described below.

The camera ECU 112 of the present embodiment may also output data indicating a reliability of the recognition result of the image frame. The reliability of the recognition result may be calculated based on, for example, an amount of rainfall, a presence or absence of backlight, an illuminance of an external environment. The reliability of the recognition result may be a score indicating a matching level of the feature amount. The reliability of the recognition result may be a probability value indicating a certainty of the recognition result output as the identification result by the identifier 113. The probability value may correspond to the matching level of the feature amount described above.

The millimeter wave radar 12 is a device that transmits a probe wave such as a millimeter wave or a quasi-millimeter wave toward the front of the subject vehicle and that detects the relative position and relative speed of an object with respect to the subject vehicle by analyzing a reception data of a reflected wave. The reflected wave is the probe wave which is reflected by the object and returned to the millimeter wave radar 12. For example, the millimeter wave radar 12 is installed in a front grille or a front bumper. The millimeter wave radar 12 includes a radar ECU that identifies the type of the detected object based on a size of the detected object, a traveling speed of the detected object, or a signal reception strength of the reflected wave from the detected object. The radar ECU outputs a detection result to the automated driving ECU 30. The detection result is data indicating the type, the relative position (direction and distance), and the reception strength of the detected object. Objects to be detected by the millimeter wave radar 12 may include other vehicles, pedestrians, maintenance holes (steel plates), and three-dimensional structures such as landmarks.

Object recognition processing based on an observation data may be executed by an ECU outside the sensor, such as the automated driving ECU 30. In that case, the front camera 11 or the millimeter wave radar 12 may provide the observation data to the automated driving ECU 30 as the detection result data. The observation data of the front camera 11 is the image frame. The observation data of the millimeter wave radar is data indicating distance, reception strength, and relative velocity for each detection direction. The observation data of the millimeter wave radar may be data indicating the relative position and the signal reception strength of the detected object.

The front camera 11 and the millimeter wave radar 12 correspond to outside-monitoring sensors that monitor the surroundings of the subject vehicle. In addition to the front camera 11 and the millimeter wave radar 12, a LiDAR (Light Detection and Ranging/Laser Imaging Detection and Ranging), sonar, etc., can be used as an outside-monitoring sensor. Further, the automated driving system 1 may include an outside-monitoring sensor whose detection range is the rear or lateral area of the subject vehicle, in addition to the outside-monitoring sensor whose main detection range is the front area of the subject vehicle. For example, the automated driving system 1 may include a rear camera, a side camera, or a rear millimeter wave radar.

The vehicle state sensor 13 is a sensor group that detects information related to a state of the subject vehicle. The vehicle state sensor 13 includes a vehicle speed sensor, a steering angle sensor, an acceleration sensor, and a yaw rate sensor. The vehicle speed sensor detects a traveling speed of the subject vehicle. The steering angle sensor detects a steering angle of the subject vehicle. The acceleration sensor detects acceleration such as longitudinal acceleration and lateral acceleration of the subject vehicle. The yaw rate sensor detects an angular velocity of the subject vehicle. The vehicle state sensor 13 outputs a detection result to the in-vehicle network IvN. The detection result is data indicating a current value of physical quantity to be detected.

A combination of sensors used by the automated driving system 1 as the vehicle state sensor 13 may be appropriately designed, and it is not necessary to include various type of sensors as described above. The automated driving system 1 can also include an illuminance sensor, a rain sensor, or a wiper speed sensor as the vehicle state sensor 13. The illuminance sensor is a sensor that detects the illuminance around the subject vehicle. The rain sensor is a sensor that detects rainfall. The wiper speed sensor is a sensor that detects an operation speed of a windshield wiper. The operation speed of the windshield wiper includes an operation interval.

The locator 14 is a device that generates highly accurate position information of the subject vehicle by complex positioning that combines multiple pieces of information. The vehicle position is represented by three-dimensional coordinates of latitude, longitude, and altitude, for example. A vehicle position information generated by the locator 14 is output to the in-vehicle network IvN and is used by the automated driving ECU 30. The locator 14 is realized with use of a GNSS receiver, for example. The GNSS receiver is a device that sequentially detects a current position of the GNSS receiver by receiving navigation signals (i.e., positioning signals) transmitted from positioning satellites included in a global navigation satellite system (GNSS). For example, when the GNSS receiver can receive the positioning signals from four or more positioning satellites, the GNSS receiver outputs positioning results every 100 milliseconds. The GNSS may be the GPS, the GLONASS, the Galileo, the IRNSS, the QZSS, or the Beidou. The locator 14 may calculate sequentially the position of the subject vehicle by combining a positioning result of the GNSS receiver and an output of an inertial sensor.

The locator 14 may be configured to be capable of performing the localization process. The localization process is a process of specifying a detailed position of the subject vehicle by collating a coordinate of the landmark specified based on an image captured by the front camera 11 with a coordinate of the landmark registered in the map data. The landmark is, for example, a guide sign such as a direction sign, the traffic light, a pole, or the stop line. The localization process may be performed by collating the three-dimensional point group data generated by the LiDAR with the three-dimensional map data.

The map data including information about various features may be stored in a non-volatile storage device (not shown) or may be downloaded from an external server as needed and stored in a predetermined volatile memory. A part or all the functions of the locator 14 may be provided in the automated driving ECU 30 or the HCU 20. A functional arrangement of the automated driving system 1 can be appropriately changed.

The body ECU 15 is an ECU that integrally controls in-vehicle devices included in a body system. Here, the in-vehicle devices of the body system may include the lighting device 151, a window motor, a door lock actuator, a seat motor, a side mirror motor, and a wiper motor, for example. The body ECU 15 controls the lighting device 151 based on the user operation on a light switch, a detection value of the illuminance sensor, time information, or an instruction signal from the automated driving ECU 30. For example, the body ECU 15 turns on headlights based on a fact that an external illuminance detected by the illuminance sensor is less than an automatic lighting threshold. The automatic lighting threshold is a threshold for automatically turning on the headlight. The external illuminance indicates an illuminance outside the subject vehicle. The body ECU 15 corresponds to a lighting control device. In another embodiment, an ECU of the lighting control device may be provided between the body ECU 15 and the lighting device 151.

The lighting device 151 controls lighting states of light sources arranged at the left and right front corners, such as the headlights, fog lamps, and notification lamps. The headlights are also called headlamps. The headlights here can emit low beams and high beams with different light illuminating ranges. The high beams illuminate an area farther from the subject vehicle than an area illuminated by the low beams since the high beams emitting light almost horizontally. For example, the high beams are configured to illuminate a road surface 100 m ahead of the subject vehicle. The high beams may be called running headlights. The low beams are lights casted downwards more than the high beams. The low beams illuminate the area closer to the subject vehicle than the area illuminated by the high beams. For example, the low beams are configured to illuminate a road surface 40 m ahead. The low beams are also called passing headlights. The fog lamps are lighting equipment to improve a visibility of the subject vehicle in bad weather such as fog. The fog lamps are also called front fog lights. The notification lamps indicate, for example, clearance lamps (CLL), winkers, daytime running lights (DRL), hazard lamps, or the like.

The lighting device 151 is configured as a four-lamp headlight, for example. That is, the lighting device 151 has light sources for the high beams and light sources for the low beams. The light sources may be various elements such as a light emitting diodes (hereinafter referred to as LEDs) and an organic light emitting transistors. The light sources may be realized with use of multiple light source elements. Some or all of the light sources for the low beams may also be used as the light sources for the high beams.

In the lighting device 151, the high beams are set to be greater in brightness than the low beams. For example, the number of LEDs for the high beams is greater than the number of LEDs for the low beams. Further, the lighting device 151 may be configured to be capable of dynamically changing an illuminating range by individually controlling lighting states of LEDs for the high beams. For convenience, a technique of dynamically changing the illuminating range of the high beams according to a scene by individually controlling LEDs for the high beams is referred to as an adaptive high beam control. When the light sources are LEDs, the lighting device 151 may adjust the brightness by PWM (Pulse Width Modulation) control of current flowing to the LEDs. Such a dimming method is also called a PWM dimming. A difference in brightness between the high beams and the low beams may be realized by adjusting a duty ratio in PWM control. Of course, the light sources of the headlights may be a halogen lamp or the like.

The lighting device 151 may be configured to be capable of changing an illuminating direction of light of the high beams dynamically within a predetermined angular range in a vertical direction. For example, the lighting device 151 may be configured to switch between a basic state and a slightly downward state. The basic state is a state in which light is emitted horizontally or downward by a predetermined amount (e.g., 3 degrees) from the horizontal direction to illuminate 100 meters ahead. The slightly-downward state is a state in which light is emitted downward by a predetermined angle from the basic state. The slightly-downward state may be, for example, a mode in which light is emitted 1 to 5 degrees downward from the basic state at a brightness equivalent to the high beams. The illuminating direction may be adjusted dynamically by changing an angle of the light sources relative to the vehicle body using a motor. The slightly-downward state may be realized by application of the adaptive high beam control.

For convenience, lights emitted more downward than a normal mode (i.e., the basic state) at the brightness equivalent to the high beams is referred to as semi-high beams. The semi-high beams correspond to beams larger in illuminating range and higher in brightness than the low beams. The semi-high beams may be beams that illuminate a road surface up to 60-70 m ahead more brightly than the low beams. The semi-high beams correspond to an enhanced version of the low beams, in one aspect. The semi-high beams can also be called middle beams or enhanced low beams. The lighting device 151 in the present embodiment is configured to emit the semi high beams with use of the light sources for the high beams, but the semi-high beams may be provided by other means. The lighting device 151 may be equipped with light sources for the semi-high beams in addition to the light sources for high beams. The lighting device 151 may use some of the LEDs for the high beams to form the semi high beams.

The V2X onboard device 16 is a device for the subject vehicle to perform wireless communication with another device. The V2X onboard device 16 includes a wide area communication module and a short-range communication module as communication modules. The wide area communication module is a communication module for executing wireless communication compliant with a predetermined wide area wireless communication standard. The wide area wireless communication standard here, may be any standard, such as long term evolution (LTE), 4G, or 5G. The subject vehicle functions as a connected car that can be connected to the Internet by mounting the V2X onboard device 16. For example, the automated driving ECU 30 can download the latest high-definition map data from a map server in cooperation with the V2X onboard device 16. The wide area communication module performs wireless communication with another device via a radio base station. In addition to this, the wide area communication module may also be configured to be capable of performing wireless communication directly with other devices without the radio base station, using a communication method compliant with the wide area wireless communication standard. That is, the wide area communication module may be configured to perform cellular V2X.

The short range communication module is a communication module for directly performing wireless communication with another moving object or a roadside unit existing around the subject vehicle in accordance with a short range communication standard. The short range communication standard is a communication standard in which a communication range is limited within several hundred meters. The roadside unit is a communication facility installed along a road. The short range communication standard may be any standard, such as a wireless access in vehicular environment (WAVE) standard defined under IEEE1609, or a dedicated short range communications (DSRC) standard.

The V2X onboard device 16 transmits a detection capability report to another vehicle under a control of the automated driving ECU 30. The detection capability report may be information indicating an actual (effective) level of a detection capability evaluated by the automated driving ECU 30 for each outside-monitoring sensor. The detection capability can be referred as a detection performance or detection accuracy. The detection capability report includes location information and time information at a time the detection capability is evaluated. Also, the detection capability report includes source information that allows a receiving vehicle to identify a sending vehicle (i.e., source). The V2X onboard device 16 can receive a detection capability report transmitted from the other vehicle.

A manner of transmission and reception of the detection capability report may be broadcasting or geocasting. Broadcasting indicates a manner of sending data to all destinations, i.e., without limiting the destination. Geocasting is a flooding communication mode in which a destination is specified by location information. Data transmitted by geocasting is received by vehicles existing in a geocast area designated in the transmitted data. According to geocasting, vehicles can transmit data without individually identifying vehicles existing in an area subject to information distribution.

The V2X onboard device 16 may transmit a communication packet corresponding to the detection capability report to the map server under the control of the automated driving ECU 30. The map server may be an external server that generates a dynamic map.

The DSM 17 is a sensor that sequentially detects the user's state based on a face image of the user. Specifically, the DSM 17 captures an image of a face of the user using a near-infrared camera, and executes image recognition processing on the captured image to sequentially detect a face direction, a gaze direction, or a degree of eyelid opening of the user. For example, the DSM 17 is arranged at a top of a steering column cover, a top of an instrument panel, a room mirror. The near-infrared camera faces toward a headrest of the driver's seat to capture the face of the user. The DSM 17 sequentially outputs an occupant state data to the in-vehicle network IvN. The occupant state data indicates the face direction, the gaze direction, or the degree of eyelid opening of the user specified based on the captured image. The DSM 17 corresponds to an example of an in-vehicle camera.

The notification device 18 is a group of devices used to notify the user of an operating status of the automated driving system 1. The notification device 18 includes a HUD 18A, a meter display 18B, and a sound device 18C, as shown in FIG. 3, for example. HUD is an abbreviation for Head-Up Display.

The HUD 18A is a device that projects image light onto a predetermined area of a windshield and displays a virtual image that can be perceived by the user. The HUD 18A projects the image light based on control signals and video data that are input from the HCU 20. The HUD 18A includes a projector, a screen, and a concave mirror. The windshield (front glass) can function as a screen.

The meter display 18B is a display placed in front of the driver seat in the instrument panel. The meter display 18B is capable of displaying various colors. The meter display 18B may be provided by a liquid crystal display, an organic light emitting diode (OLED) display, a plasma display, or the like. The HUD 18A or the meter display 18B corresponds to a display device. The sound device 18C is a device that outputs sound from at least one speaker based on a control signal input from the HCU 20. The expression “sound” in the present disclosure also includes voice and music.

The automated driving system 1 does not need to include all the devices described above as the notification device 18. The notification device 18 may include a center display which is a display placed in a center section of the instrument panel in a width direction of the subject vehicle. The meter display 18B in the following description can be replaced with the center display.

The input device 19 is a device for receiving the user's operation to the automated driving system 1. The input device 19 may be a steering switch provided on a spoke portion of a steering wheel, a lever provided on a steering column portion, a touch screen laminated on the center display, or the like. The automated driving system 1 may include multiple types of devices described above as the input device 19. The user's operation can be read as a user's action or instruction input. The input device 19 outputs a user operation signal to the in-vehicle network IvN, and the user operation signal is an electric signal corresponding to the operation performed by the user to the input device 19. The operation signal includes information that indicates details of the user's operation.

The HMI system 2 of this embodiment includes a mode change switch 19A as the input device 19, for example. The mode change switch 19A is arranged on the spoke portion as one of steering switches, for example. The mode change switch 19A is a switch for the user to change the driving mode. The mode change switch 19A includes an AD (Automated Driving) permission switch and an AD terminating switch. The AD permission switch is a switch to request or permit starting the automated driving mode. The AD terminating switch is a switch to cancel (i.e., terminate) the automated driving mode. The AD permission switch and the AD terminating switch may be provided separately or may be the same switch. Here, as an example, the AD permission switch and the AD terminating switch are provided by the same switch. That is, the same switch functions as the AD permission switch in a mode other than the automated driving mode, and functions as the AD terminating switch in the automated driving mode. The mode change switch 19A corresponds to a switch for activating or stopping the automated driving function provided by the automated driving ECU 30.

The automated driving system 1 may be configured to receive user's commands for switching the driving modes via voice input. The input device 19 may include a voice input device that has a microphone and a processor that performs voice recognition process on voice data collected by the microphone. The voice recognition process itself may be performed by an external server.

The HCU 20 integrally controls information presentation to the user. The HCU 20 controls a display contents on the HUD 18A based on the control signal input from the automated driving ECU 30 and/or the operation signal input from the input device 19. For example, the HCU 20 displays an image representing the operation state of the automated driving function and/or an image of a takeover request on the HUD 18A and the meter display 18B, based on information provided by the automated driving ECU 30. The HCU 20 causes the sound device 18C to output a notification sound or a predetermined voice message.

The HCU 20 includes a computer, and this computer may include a processing unit 21, a RAM 22, a storage 23, a communication interface 24, and a bus connecting these components. The processing unit 21 is provided by hardware circuit and executes a calculation process in cooperation with the RAM 22. The processing unit 21 includes at least one calculation core i.e., processor, such as a CPU. The processing unit 21 executes, by accessing the RAM 22, various processes for functioning as the functional blocks described later. The storage 23 includes a non-volatile storage medium, such as a flash memory. The storage 23 stores an information presentation program, which is a program to be executed by the processing unit 21. The communication interface 24 is a circuit for communicating with other devices via the in-vehicle network IvN. The communication interface 24 may be provided by an analog circuit element, an IC, or the like.

The automated driving ECU 30 is an ECU that executes a part or all of the driving operations instead of the user by controlling a traveling actuator based on detection results of the front camera 11 and/or the millimeter wave radar 12. The automated driving ECU 30 is also called an automatic operation device. The traveling actuator includes, for example, a brake actuator as a braking device, an electronic throttle, and a steering actuator. The steering actuator includes an EPS (Electric Power Steering) motor. Another ECU may intervene between the automated driving ECU 30 and the traveling actuator. The other ECU is, for example, a steering ECU for steering control, a power unit control ECU for acceleration/deceleration control, or a brake ECU.

The automated driving ECU 30 has multiple driving modes with different automation levels. Here, as an example, the automated driving ECU 30 has a fully manual mode, a driving assistance mode, and the automated driving mode and is configured to be switched between these driving modes. Each driving mode differs in the range of driving tasks that the user is responsible for, in other words, differs in the range of driving tasks in which the system intervenes. The system here indicates the automated driving system 1. The system may be substantially understood as the automated driving ECU 30.

The fully manual mode is a driving mode in which the user performs all driving tasks. The fully manual mode corresponds to the automation level 0. Therefore, the fully manual mode can also be referred to as a level 0 mode.

The driving assistance mode is a driving mode in which the system executes or assists speed control and supports the steering operation. The user is responsible for the steering operation in the driving assistance mode. The driving assistance mode corresponds to a driving mode in which the ACC function or an LTA (Lane Tracing Assist) function are operating, for example. The ACC function may be a function that causes the subject vehicle to travel regularly at a target speed. The ACC function may also be a function that causes the subject vehicle to follow a preceding vehicle while keeping the inter-vehicle distance with the preceding vehicle constant. The ACC corresponds to a vehicle following control. A target value of the traveling speed in the ACC is set by the user within a preset speed range. A target value of the inter-vehicle distance to the preceding vehicle in the ACC is set by the user within a preset range. The LTA function is a function that controls steering to maintain the subject vehicle in a lane based on lane information. The driving assistance mode corresponds to the automation level 2.0. The driving assistance mode can also be referred to as a level 2 mode.

The fully manual mode and the driving assistance mode correspond to driving modes in which hands-on and eyes-on of the user are required. The hands-on means that the user holds the steering wheel. The hands-off means that the user does not hold the steering wheel. The eyes-on means that the user monitors the surrounding traffic conditions such as the front of the subject vehicle. The eyes-off means that the user does not monitor the surrounding traffic condition, that is, looking away from the front of the subject vehicle.

In the fully manual mode and the driving assistance mode, the user is responsible for at least a part of the driving tasks. In other words, these driving modes are driving modes in which the user is involved in at least a part of driving tasks. Therefore, in this disclosure, the fully manual mode and the driver assistance mode are collectively referred to as a user-involvement mode. The user-involvement mode can also be referred to as a manual driving mode as an antonym of the automated driving mode. The manual driving in this disclosure can also include a state in which driving assistance is being performed by the system.

The automated driving mode is a driving mode in which the system performs all driving tasks. Here, as an example, the automated driving mode is a driving mode corresponding to the automation level 3. The automated driving mode may be a driving mode that the system operates automated driving of the automation level 4 or 5. The automated driving mode corresponds to a driving mode in which the eyes-off is allowable, in other words, the user can perform a second task.

The second task is an activity other than driving tasks permitted to the user. The second task is a predetermined specific action. The second task can be called a secondary activity, other activity, or the like. The secondary task may include some or all of the following activities: watching videos, operating smartphones, reading e-books, and eating with one hand. In the automated driving mode equivalent to the level 3, the user is required to remain ready to respond promptly to a request from the automated driving system 1 to take over driving operations. Therefore, in the automated driving mode equivalent to the level 3, the user will be prohibited from performing certain activities such as sleeping, doing a task in which the user cannot release both hands immediately, and leaving the driver's seat. Acceptable actions as the second tasks and prohibited actions may be set based on the laws and regulations of the region where the subject vehicle is used.

In the automated driving mode, the automated driving ECU 30 automatically performs steering, acceleration, and deceleration (in other words, braking) of the subject vehicle such that the subject vehicle travels along the road to a destination set by the user. The switching of the driving mode is automatically executed due to reaching a system limit and an exit from the ODD, in addition to the user operation.

The ODD includes, for example, (a) the traveling road is a highway or a motorway having a median strip, the guard rail and two or more lanes each way, and (b) the subject vehicle is traveling in a traffic congestion. The traveling road means a road on which the subject vehicle is traveling. The traffic congestion may be, for example, defined as a situation in which the preceding and following vehicles are present within a predetermined distance from the subject vehicle and the traveling speed is equal to or less than 60 km/h. The ODD may include (c) a rainfall is equal to or less than a predetermined threshold, (d) the outside-monitoring sensor including the front camera 11 is operated normally. In addition, the ODD may include (e) no fallen objects or parked vehicles exist within a predetermined distance from the subject vehicle on the road, and (f) no traffic lights or pedestrians within a detection range of the outside-monitoring sensor. A condition for determining whether automated driving is possible/impossible, in other words, a detailed condition for defining the ODD can be designed as appropriate.

Here, as an example, the system determines that automated driving is possible in each of the following cases: when traveling in the traffic congestion, and when traveling on a specific road segment. The automated driving in the traffic congestion can be called an automated driving in the congestion. The automated driving in the specific road section can be called an area-limited automated driving. As described above, depending on the settings of the ODD, there may be a model of the automated driving ECU 30 that allows automated driving only when the subject vehicle is traveling on a specific road section and in the traffic congestion.

The automated driving system 1 does not have to include all the above driving modes. For example, the combination of driving modes equipped in the automated driving system 1 may be only the fully manual mode and the automated driving mode. Further, the driving assistance mode may include an advanced assistance mode. The advanced assistance mode is a driving mode in which an LTC (Lane Trace Control) function operates. In the advanced assistance mode, the hands-off is allowable but the eyes-on is required The LTC function is a function that controls the steering such that the subject vehicle travels within an ego-lane. The LTC function includes a function of generating a scheduled traveling line along the ego-lane. The difference between the LTC and LTA is whether the user is a substantial performer of the steering. That is, in the LTA, an entity performing the steering is the user, whereas in the LTC, the entity of steering is the system. However, in a broad sense, the LTC may also be included in the LTA. The advanced assistance mode corresponds to the so-called automation level 2.1 to 2.9. The Advanced assistance mode can also be referred to as a hands-off level 2 mode.

The automated driving ECU 30 includes a computer, and the computer includes a processing unit 31, a RAM 32, a storage 33, a communication interface 34, and a bus connecting these. The storage 33 stores a vehicle control program, which is a program to be executed by the processing unit 31. Executing the vehicle control program by the processing unit 31 corresponds to executing a vehicle control method corresponding to the vehicle control program. The vehicle control program includes application software corresponding to the above-described ACC, LTA, and LTC. A processor that executes processing related to driving assistance may be provided separately from a processor that executes processing related to automated driving.

<A Configuration of Automated Driving ECU>

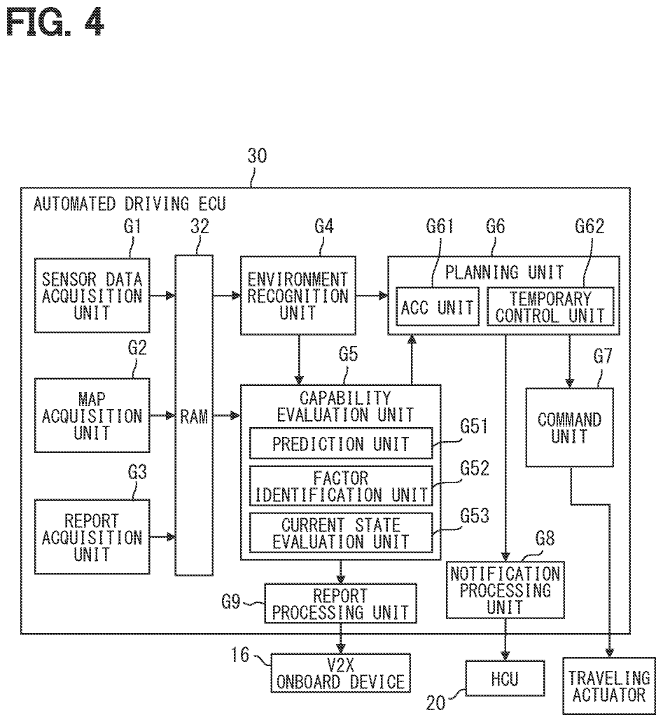

The automated driving ECU 30 includes functional units shown in FIG. 4 which are realized by executing the vehicle control program. That is, the automated driving ECU 30 includes a sensor data acquisition unit G1, a map acquisition unit G2, report acquisition unit G3, an environment recognition unit G4, a capability evaluation unit G5, a planning unit G6, a command unit G7, a notification processing unit G8, and a report processing unit G9.

The sensor data acquisition unit G1 is configured to acquire a variety of information for implementing driver assistance or automated driving. The sensor data acquisition unit G1 acquires the detection result (i.e., sensing information) from the various outside-monitoring sensors including the front camera 11. The sensing information includes a position, a moving speed, and a type of the detected object existing around the subject vehicle. The detected object may be another moving body, a feature, or an obstacle. The sensor data acquisition unit G1 acquires the traveling speed of the subject vehicle, acceleration, yaw rate, and the external illuminance from the vehicle state sensor 13. The sensor data acquisition unit G1 acquires the position information of the subject vehicle from the locator 14. In addition, the sensor data acquisition unit G1 acquires the gaze direction of the user from the DSM 17.

The map acquisition unit G2 acquires dynamic map data corresponding to a current position of the subject vehicle. The map acquisition unit G2 may acquire the dynamic map data from the map server existing outside the vehicle, the roadside unit, or the other vehicle around the subject vehicle. The map server, the roadside unit, or the other vehicle corresponds to an external device. Map data corresponding to the current position of the subject vehicle is, for example, map data related to a road section in which the subject vehicle is scheduled to pass within a predetermined time. The map data corresponding to the current position may be map data of an area within a predetermined distance from the current position, or data of a mesh corresponding to the current position.

The dynamic map data here indicates local weather information. The local weather information may include, for example, presence/absence and density of fog, an amount of rainfall, an amount of snowfall, or presence/absence of sandstorm (wind dust). The dynamic map may also include road condition associated with local weather conditions such as snowfall or sandstorm at each location. The road condition also includes whether the road is covered with snow, sand, or the like. The map acquisition unit G2 may acquire the dynamic map data including an angle (altitude) of the sun with respect to the horizon, a direction of the sun with respect to a road extension direction, or the external illuminance of each point.

In addition, the map acquisition unit G2 acquires the dynamic map data including, for example, a road section with a traffic restriction, a congested road section, and a position of dropped object. Information of the congested road section may include information about a start point and an end point of the congested road section. The map acquisition unit G2 may acquire, as the dynamic map data, an average trajectory for each lane, which is obtained by integrating travel trajectories of multiple vehicles, from the external server. The average trajectory for each lane can be used, for example, to determine a target path in the automated driving of the subject vehicle. The dynamic map data indicates dynamic, quasi-dynamic, and quasi-static traffic information that can be used as a reference for a driving control of the subject vehicle.

Furthermore, the map acquisition unit G2 may acquire static map data indicating road connection relationships and road structures within a predetermined distance from the current position. The map acquisition unit G2 may acquire the static map data from the external server, or a map database installed in the subject vehicle. The static map data may be navigation map data, which is map data used for navigation, or high-definition map data available for automated driving. The navigation map data is map data with positioning errors ranging from a few meters to 5 meters. The high-definition map data corresponds to map data with higher precision than the navigation map data. The high-definition map may be map data with positioning errors of 10 cm or less. The high-definition map data includes, for example, three-dimensional shape information of roads, position information of lane markings, position information of road edges, and position information of landmarks such as traffic lights.

The report acquisition unit G3 acquires the detection capability report transmitted by the other vehicle through the V2X onboard device 16. As a result, the automated driving ECU 30 can acquire a current state of the detection capability of the outside-monitoring sensor installed in another vehicle (i.e., preceding vehicle) traveling ahead of the subject vehicle. The detection capability report from the preceding vehicle is useful for predicting a change of the detection capability of the outside-monitoring sensor of the subject vehicle.

Various information sequentially acquired by the sensor data acquisition unit G1, the map acquisition unit G2, and the report acquisition unit G3 is stored in memory, such as the RAM 32, and is used by the environment recognition unit G4 and other units. The various information can be classified by type and stored in the memory. For example, the various information can be sorted and stored with the latest data first. The data in which a certain time elapses after acquisition can be discarded from the memory.

The environment recognition unit G4 recognizes a surrounding environment of the subject vehicle based on the vehicle position information, information about the detected object, and the map data. The environment recognition unit G4 may recognize the surrounding environment by sensor fusion processing. The sensor fusion processing is a processing integrates the detection results of multiple outside-monitoring sensors, such as the front camera 11 and millimeter wave radar 12, with a predetermined weight.

The surrounding environment includes position, type, and speed of each object around the subject vehicle. The surrounding environment also includes a curvature of the traveling road, a number of lanes, an ego-lane number, weather, the road condition, and whether the traveling road is congested. The ego-lane number indicates in which lane the subject vehicle is traveling from or relative to the left road edge or right road edge. The locator 14 may identify the ego-lane number. The weather and road condition can be specified by combining the recognition result of the front camera 11 and the weather information acquired by the map acquisition unit G2. The road structure may be specified using the static map data or the recognition result of the front camera 11. The environment recognition unit G4 provides a recognition result of the surrounding environment to the capability evaluation unit G5 and the planning unit G6.

The capability evaluation unit G5 is a configuration to evaluate and predict the object detection capability of the outside-monitoring sensor such as the front camera 11. The capability evaluation unit G5 corresponds to a detection capability prediction unit. The capability evaluation unit G5 has a prediction unit G51, a factor identification unit G52, and a current state evaluation unit G53 as more detailed functions.

The prediction unit G51 is configured to predict the detection capability of the outside-monitoring sensor a predetermined prediction time ahead from the current time. The prediction time may be a value of 5 minutes or less, such as 20 seconds, 30seconds, or 1 minute. The factor identification unit G52 is a configuration to identify a factor of deterioration in the detection capability of the outside-monitoring sensor, when the prediction unit G51 predicts that the detection capability of the outside-monitoring sensor falls below a predetermined required level within the prediction time period. The required level here corresponds to a performance quality required to continue the automated driving. The current state evaluation unit G53 determines a current detection capability of the outside-monitoring sensor. The current state evaluation unit G53 is configured to determine whether the outside-monitoring sensor is functioning normally, or whether its performance is temporarily deteriorated for some reason.

For example, the prediction unit G51 predicts whether the detection capability of the outside-monitoring sensor is likely to fall below the required level within the prediction time period based on the dynamic map data acquired by the map acquisition unit G2. The outside-monitoring sensor may be the front camera 11, the millimeter wave radar 12, the LiDAR, or the like, as described above. The prediction unit G51 corresponds to a configuration which predicts whether the detection capability of the surroundings monitoring sensor will fall below the required level within the prediction time period from the current time. The required level may be specifically set for each outside-monitoring sensor. The capability evaluation unit G5 may evaluate the detection capability for each outside-monitoring sensor.

For example, the prediction unit G51 predicts whether a detection capability of the front camera 11 will fall below the required level, based on weather information or road conditions of a road section that the vehicle is scheduled to pass within a predetermined time period. A state in which the detection capability of the front camera 11 is below the required level corresponds to a state in which a recognizable distance of the camera ECU 112 is less than a predetermined required value. The recognizable distance is a distance at which the camera ECU 112 can detect an object of a given dimension or a defined object. For example, the required value of the recognizable distance may be set to 50 m, 100 m, 150 m. The required value of the recognizable distance may be set to a larger value as the object is larger. Also, the required value of the recognizable distance may vary depending on the type of object.

The prediction unit G51 may use a variety of methods to determine whether the detection capability of the front camera 11 will fall below the required level. For example, the prediction unit G51 determines whether a dense fog area exists ahead of the subject vehicle based on the weather information. Then, when the dense fog area exists ahead of the subject vehicle, the prediction unit G51 predicts that the detection capability of the front camera 11 is likely to fall below the required level. In this case, the factor identification unit G52 determines that a deterioration factor is a fog. The deterioration factor here indicates a factor which deteriorate the detection capability.

A range indicated by “ahead of the subject vehicle” here means a road section through which the subject vehicle passes within the prediction time from the current time. The dense fog area conceptually indicates a road section where visibility is less than 100 meters due to fog. The dense fog area may be a road section where multiple vehicles have passed with their fog lights turned on. The map server can determine the dense fog area based on the behavior of multiple vehicles. The prediction unit G51 may determine that the dense fog area exists in front of the subject vehicle when the report acquisition unit G3 obtains that multiple vehicles have turned on their fog lights from multiple vehicles traveling ahead of the subject vehicle through inter-vehicle communication.

Further, the prediction unit G51 predicts that the detection capability of the front camera 11 will fall below the required level when a westering sun condition is satisfied within the prediction time period. In this case, the factor identification unit G52 determines that the deterioration factor is the westering sun. The westering sun here means a light from the sun whose angle with respect to the horizon line is, for example, 25 degrees or less. The westering sun condition may be predetermined. For example, the westering sun condition may be specified using at least any of the following items: time of day, azimuth angle of travel, and altitude of the sun. For example, the westering sun condition may include (a) the current time is between 3:00 p.m. and 8:00 p.m., and (b) a direction of travel of the subject vehicle is within 30 degrees of a direction of sunset. The automated driving ECU 30 may obtain information such as a position of the sun from the map server as a part of dynamic map data, or from another vehicle through inter-vehicle communication. The processing unit 31 may internally calculate whether the westering sun condition is satisfied based on the time and seasonal information.

Of course, the detection capability of the front camera 11 does not always fall below the required level when the westering sun condition is satisfied. Depending on a performance of the front camera 11, such as a value of a dynamic range, the detection capability may remain above the required level even when the westering sun condition is satisfied. The required level of the front camera 11 may be modified according to the model and software version of the front camera 11.

Furthermore, the prediction unit G51 determines whether a heavy rain area exists ahead of the subject vehicle based on the weather information. When the heavy rain area exists ahead of the subject vehicle, the prediction unit G51 predicts that the detection capability of the front camera 11 will fall below the required level. In this case, the factor identification unit G52 determines that the deterioration factor is the heavy rain.

The heavy rain here may be defined as rain falling at a rate that a precipitation per hour exceeds a predetermined threshold (for example, 50 mm). The heavy rain also includes localized heavy rain with less than an hour (for example, several tens of minutes) of rainfall at a certain point. Substantially, the heavy rain area may be a road section in which multiple vehicles operate windshield wipers at a predetermined speed. The map server can determine the heavy rain area based on behavior information of multiple vehicles or precipitation information generated by a weather radar. The prediction unit G51 may determine that the heavy rain area exists ahead of the subject vehicle when the report acquisition unit G3 obtains reports indicating that multiple vehicles operate their windshield wipers at a speed equal to or higher than a predetermined threshold, from multiple vehicles traveling ahead of the subject vehicle through inter-vehicle communication.

Furthermore, the prediction unit G51 determines whether a blurred marking area exists ahead of the subject vehicle. When the blurred marking area exists ahead of the subject vehicle, the prediction unit G51 predicts that the detection capability of the front camera 11 is likely to fall below the required level. The blurred marking area here indicates a road section where the lane marking is unclear due to deterioration of paint such as abrasion. The blurred marking area may include a road section where the lane marking has completely disappeared. In addition, the blurred marking area may include a snow-covered area where the road surface is covered with snow and a sand-covered area where the road surface is covered with sand. The sand-covered area may be an area where the lane marking is temporarily covered with sand due to a sandstorm on a paved road with lane markings.

The blurred marking area means an area where the system has difficulty detecting a marking line by image recognition. The map server may determine the blurred marking area and distribute information on the blurred marking area to vehicles including the subject vehicle. The prediction unit G51 may determine that the blurred marking area exists ahead of the subject vehicle when the report acquisition unit G3 obtains reports indicating that the recognition rate of the lane marking has deteriorated from multiple vehicles traveling ahead of the subject vehicle through inter-vehicle communication. By analyzing the image of the front camera 11 or using the dynamic map data, the factor identification unit G52 may identify whether the deterioration factor is blurring (deterioration) of lines, snow, or dust. However, there are various conceivable reasons why the lane markings become unclear. Therefore, when the prediction unit G51 has determined that the detection capability of the front camera 11 falls below the required level because of the existence of the blurred marking area, the factor identification unit G52 may determine that the deterioration factor is unknown.

The current state evaluation unit G53 calculates an effective recognition distance. The effective recognition distance is a range in which the front camera 11 can actually recognize the landmark. A value of the effective recognition distance varies due to external factors such as fog, rainfall, or westering sun, unlike a designed recognition limit distance. Even when the designed recognition limit distance is 200 m, the effective recognition distance may decrease to less than 50 m depending on the precipitation. The current state evaluation unit G53 may calculate the effective recognition distance based on an average value of farthest recognition distances observed within a predetermined time period. A farthest recognition distance of a landmark means a distance from the subject vehicle to the landmark when the front camera 11 first detects the landmark. For example, when the farthest recognition distances to the four landmarks observed within the last predetermined time are 50 m, 60 m, 30 m, and 40 m, the effective recognition distance can be calculated to be 45 m. The farthest recognition distance of a certain landmark indicates a recognizable distance at a time point when the front camera 11 detects that landmark for the first time.

The effective recognition distance of landmark may be reduced by factors other than weather, such as occlusion by the preceding vehicle. Thus, when the preceding vehicle is present within a predetermined distance from the subject vehicle, the current state evaluation unit G53 may omit to calculate the effective recognition distance. When the road ahead of the subject vehicle is not a straight road, that is, when the road ahead is a curved road, the effective recognition distance may also decrease. Therefore, when the road ahead is the curved road, calculation of the effective recognition distance may be omitted. The curved road here may be a road having a curvature equal to or greater than a threshold value.

The current state evaluation unit G53 may calculate an effective recognition distance to the lane marking instead of or in addition to the landmark. The effective recognition distance of lane marking corresponds to information indicating how far the front camera 11 can recognize the road surface. A lane marking which is used to calculate the effective recognition distance among lane markings on the traveling road may be a lane marking on the left or right side or both sides of the ego-lane. The ego-lane is a lane in which the subject vehicle is traveling. This is because an outer lane marking of a lane adjacent to the ego-lane may be blocked by other vehicles. The effective recognition distance of lane marking may be an average value of the recognition distances observed within the most recent predetermined time period. The effective recognition distance of lane marking may be a moving average of the recognition distances. According to the configuration which determines the effective recognition distance of lane marking by the moving average, instantaneous fluctuations in the recognition distance caused by another vehicle blocking the lane marking can be reduced.

The current state evaluation unit G53 may separately calculate the effective recognition distance separately for each of a right lane marking and a left lane marking of the ego-lane. In that case, the current state evaluation unit G53 may adopt the larger one of the effective recognition distances of each of the right lane marking and the left lane marking. According to such a configuration, even when either the left or right lane marking cannot be seen due to a curve or the preceding vehicle, the current state evaluation unit G53 may accurately evaluate how far the front camera 11 can recognize the lane marking. The effective recognition distance of lane marking may be an average value of the effective recognition distance of the right lane marking and the one of the left lane marking.

The prediction unit G51 may determine a changing trend of the detection capability based on a history of the effective recognition distance or the recognition rate of lane marking or landmark in the front camera 11. Then, the prediction unit G51 may determine whether the detection capability falls below the required level within the prediction time period. For example, in a configuration in which the processing unit 31 periodically calculates the effective recognition distances of landmark, the prediction unit G51 determines whether the effective recognition distance of landmark is on a decreasing trend based on time-series data of the effective recognition distances of landmark. When the effective recognition distance of landmark is on the decreasing trend, the prediction unit G51 calculates a decreasing speed of the effective recognition distance. Then, based on the current value and the decreasing speed of the effective recognition distance of landmark, the prediction unit G51 determines whether the effective recognition distance falls below a predetermined required value within the prediction time from the current time. The required value of the effective recognition distance of landmark corresponds to the required level. For example, the required value of the effective recognition distance of landmark may be 50 m, 100 m, or 150 m.

When the processing unit 31 periodically calculates the effective recognition distances of lane marking, the prediction unit G51 may determine whether the effective recognition distance of lane marking is on a decreasing trend based on time-series data of the effective recognition distances of the lane marking. When the effective recognition distance of lane marking is on the decreasing trend, the prediction unit G51 calculates a decreasing speed of the effective recognition distance of lane marking. Then, based on the current value and the decreasing speed of the effective recognition distance of lane marking, the prediction unit G51 determines whether the effective recognition distance of lane marking falls below a required value within the prediction time from the current time. The required value of the effective recognition distance of lane marking corresponds to the required level. For example, the required value of the effective recognition distance of lane marking may be 50 m, or 100 m.

In addition, the capability evaluation unit G5 may obtain the probability value indicating the certainty of the recognition result for each detected object from the front camera 11. The prediction unit G51 may determine whether the probability value is on a decreasing trend based on time-series data of the probability value of the recognition result for an object located a predetermined distance (e.g., 100 m) ahead from the subject vehicle. When the probability value is on the decreasing trend, the prediction unit G51 calculates a decreasing speed of the probability value. Then, based on the current value and the decreasing speed of the probability value, the prediction unit G51 determines whether the recognition rate falls below a predetermined required value within the prediction time period from the current time.

Furthermore, the current state evaluation unit G53 may compare a recognition result of the front camera 11 for an object located at a predetermined distance ahead from the subject vehicle with the map data or a recognition result of another outside-monitoring sensor to calculate an accuracy rate (i.e., a percentage of correct answer) of the recognition result of the front camera 11. The prediction unit G51 may determine whether the accuracy rate of the recognition result is on a decreasing trend and whether the accuracy rate falls below a predetermined required value corresponding to the required level within the prediction time period.

As described above, the capability evaluation unit G5 determines whether the detection capability of the front camera 11 falls below the required level within the prediction time based on at least any of the dynamic map data, reports from the preceding vehicle, or the history of actual recognition results of the front camera 11. The above describes a specific example of a method to predict that the detection capability of the front camera 11 will fall below the required level within the prediction time period. The capability evaluation unit G5 can also determine whether the detection capability is likely to fall below the required level for millimeter wave radar, LiDAR, or other sensors, using indicators according to characteristics of the sensor.

The planning unit G6 is configured to plan details of a control to be executed as driving support or automated driving. In the automated driving mode, the planning unit G6 generates a traveling plan, i.e., a control plan on which the subject vehicle travels autonomously, based on the recognition result of the surrounding environment generated by the environment recognition unit G4. The control plan includes a travel position, target speed, and steering angle for each time. The traveling plan may include acceleration/deceleration schedule information for a speed adjustment along a calculated route and schedule information for steering control.

For example, the planning unit G6 performs a route-search process to generate a recommended route from the current position of the subject vehicle to a destination in mid- to long-term traveling plan. In addition, the planning unit G6 generates a traveling plan for changing the ego-lane, traveling in a lane center, following the preceding vehicle, and avoiding obstacles in a short-term traveling plan for performing travel in accordance with the in mid- to long-term traveling plan. For example, the planning unit G6 may generate, as a short-term traveling plan, a path to travel in the center of the ego-lane, or a path to follow a behavior or trajectory of the preceding vehicle. The behavior or trajectory of the preceding vehicle and the ego-lane may be recognized by the environment recognition unit G4.

The planning unit G6 may generate a candidate of plan of lane changing for overtaking when the traveling road is a road with multiple lanes on one side. The planning unit G6 may generate a traveling plan to avoid an obstacle when the environment recognition unit G4 recognizes a presence of the obstacle ahead of the subject vehicle based on the sensing information or the dynamic map data. The planning unit G6 may be configured to generate a traveling plan determined to be optimal by machine learning or artificial intelligence technology. The optimal traveling plan corresponds to a control plan that conforms to the user's instructions as long as safety is ensured. The control plan generated by the planning unit G6 is input to the command unit G7.

In addition, the planning unit G6 includes functional units which execute processes corresponding to ACC, LTA, and LTC, as sub-functions for providing the automated driving function. The functional units corresponding to ACC, LTA, and LTC can be understood as subsystems for operating automated driving. The planning unit G6 creates plans corresponding to these subsystems.

The ACC unit G61 shown in FIG. 4 is a functional module which generates a plan for following the preceding vehicle. The ACC unit G61 corresponds to a following control unit. For example, the ACC unit G61 creates and updates a plan of controlling the traveling speed as needed so as to maintain the target value of the inter-vehicle distance. The target value of the inter-vehicle distance is manually set by the user or automatically set the system according to the surround environment. The ACC unit G61 adjusts the traveling speed such that the subject vehicle follows the preceding vehicle within a speed range. The speed range is determined depending on a target value of the traveling speed manually set by the user or automatically set the system according to the surround environment.

Furthermore, the planning unit G6 has a temporary control unit G62. The temporary control unit G62 creates a plan for performing a predetermined temporary control. The temporary control is a control executed only when the capability evaluation unit G5 predicts that the detection capability of the outside-monitoring sensor falls below the required level. The temporary control will be described in detail later.

The command unit G7 generates control commands based on the control plan determined by the planning unit G6, and sequentially outputs the control commands to the traveling actuator. The command unit G7 also controls turning-on/turning-off of light sources such as a direction indicator, the headlight, and a hazard flasher in accordance with the traveling plan generated by the planning unit G6 or the surrounding environment.

The notification processing unit G8 performs a notification or a proposal to the user via the notification device 18 based on the control plan generated by the planning unit G6. For example, the notification processing unit G8 displays an image indicating the operation state of the automated driving system 1 on the HUD 18A. The operation status of the automated driving system 1 may include whether the outside-monitoring sensors are operating normally. The operation status may include a current driving mode, the traveling speed, and a time remaining before lane change. In addition, the notification processing unit G8 can also perform a notification of handover when a remaining time until a termination of automated driving due to leaving the expressway becomes equal to or less than a predetermined time. Furthermore, the notification processing unit G8 displays an image indicating that the system is executing the temporary control on the HUD 18A while the system is performing the temporary control based on the plan generated by the planning unit G6.

The report processing unit G9 generates a dataset corresponding to the detection capability report based on the evaluation result of the capability evaluation unit G5. The report processing unit G9 transmits the dataset to other vehicles and the map server. For example, the detection capability report may be a dataset indicating an actual value (effective value) of the detection capability of the outside-monitoring sensor, such as the effective recognition distance, calculated by the current state evaluation unit G53.

<Operation of Automated Driving ECU>

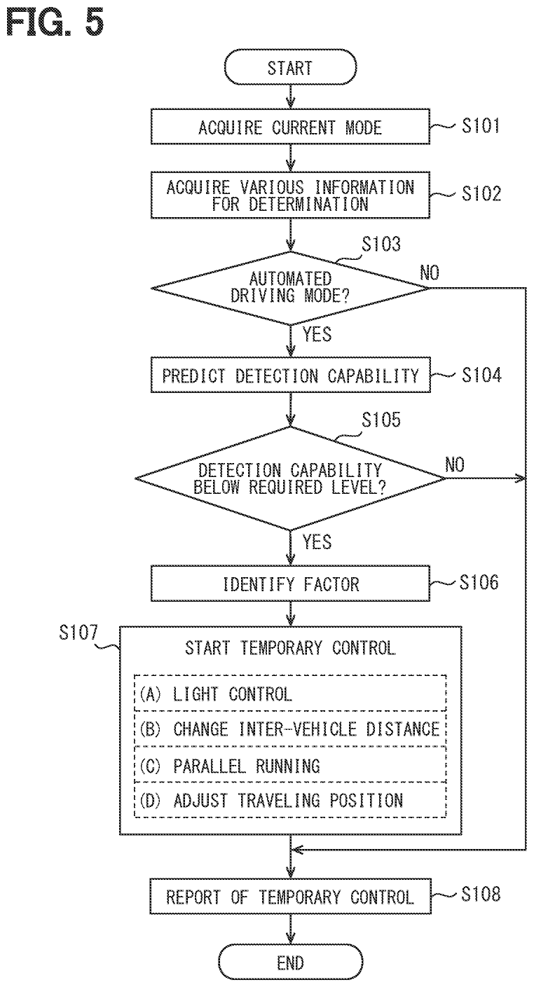

Next, a series of a process related to deterioration in the detection capability of the outside-monitoring sensor is explained using the flowchart shown in FIG. 5. This process is performed by the automated driving ECU 30. The flowchart shown in FIG. 5 may be started at a predetermined cycle, such as every second, every 10 seconds, or every minute. As an example, the process includes steps S101, S102, S103, S104, S105, S106, S107, and S108. A number and order of steps comprising the process can be changed as appropriate. As an example, a case in which the front camera 11 among the outside-monitoring sensors is a target of the process is described here. The following process may be implemented for other types of outside-monitoring sensor as well, such as the millimeter wave radar 12.

First, in step S101, the processing unit 31 reads data indicating a setting of a current mode from the RAM 32, and the process proceeds to step S102. The current mode here means a current driving mode. In step S102, the sensor data acquisition unit G1, the map acquisition unit G2, the report acquisition unit G3 acquire various information used in subsequent processing, and the process proceeds to step S103. For example, in step S102, detection results of the front camera 11, the dynamic map data, and reports from the other vehicle are obtained. In addition, step S102 may also include a step in which the automated driving ECU 30 executes some internal calculations, such as a calculation of the effective recognition distance by the current state evaluation unit G53.

In step S103 the processing unit 31 determines whether the current mode is the automated driving mode. When the current mode is the automated driving mode, an affirmative determination is made in S103, and the process proceeds to S104. On the other hand, when the current mode is not the automated driving mode, a negative determination is made in step S103, and this flow is terminated.

In step S104, the prediction unit G51 predicts whether the object detection capability of the front camera 11 falls below the required level within the prediction time from the present time, using one or more of the various methods described above. When the prediction unit G51 predicts that the detection capability of the front camera 11 falls below the required level within the prediction time from the current time, an affirmative determination is made in step S105, and the process proceeds to step S106. On the other hand, when the prediction unit G51 does not predict that the detection capability of the front camera 11 falls below the required level within the prediction time, a negative determination is made in step S105, and this flow is terminated.

In step S106, the factor identification unit G52 identifies the deterioration factor of the detection capability based on a reason that the prediction unit G51 predicts that the detection capability falls below the required level, and the process proceeds to step S107. When the reason for the determination is an unclearness of lane marking, the factor identification unit G52 may determine that the deterioration factor is unknown. A configuration for identifying the deterioration factor, such as step S106, is an optional element and may be omitted.

In step S107, the temporary control unit G62 creates a plan for executing predetermined temporary control. The automated driving ECU 30 carries out the temporary control based on the plan created by the planning unit G6 including the temporary control unit G62. The temporary control unit G62 may be understood as a configuration for executing the temporary control.

The temporary control may be a part or all of (A) light control, (B) changing a setting of the inter-vehicle distance, (C) starting a parallel running, and (D) adjusting the traveling position in a width direction. (A) Light control is a control for turning on the headlights or the fog lamps. The light control as the temporary control is performed even when the external illuminance provided from the illuminance sensor is equal to or higher than the automatic lighting threshold. That is, the temporary control unit G62 turns on the headlights or the fog lamps as temporary control even when the external illuminance detected by the illuminance sensor is equal to or higher than the automatic lighting threshold. The lighting device 151 to be turned on may be the headlights or the fog lamps. For example, when the headlights are not on before step S107, the automated driving ECU 30 turns on the headlights as the temporary control. The lighting mode of the headlights in the temporary control may be the low beams, the high beams, or the semi-high beams. The lighting mode in the temporary control may be preset. The temporary control unit G62 may select the lighting mode depending on the surround environment. Also, when the headlights have already been turned on before step S107, the temporary control unit G62 may additionally turn on the fog lamps in the temporary control. Of course, the temporary control unit G62 may turn on the fog lights as the temporary control based on predetermined rules, even when the headlights are not turned on.

Furthermore, the temporary control unit G62 may switch the lighting device 151 to be turned on responding to the deterioration factor identified by the factor identification unit G52. For example, the temporary control unit G62 turns on the fog lamps as the temporary control when the factor identification unit G52 has determined the deterioration factor is fog. This allows the automated driving ECU 30 to turn on the fog lamps even before the subject vehicle actually enters the dense fog area, in other words, even before the detection capability falls below the required level. As a result, a degree of the deterioration in the detection capability of the front camera 11 due to fog can be reduced. A possibility of interruption of the automated driving can be reduced. When the deterioration factor is unknown, the temporary control unit G62 may have the lighting device 151 emit the semi-high beams as the light control. According to this control, the system illuminates the road surface in the vicinity of the subject vehicle brighter than when the low beams are emitted, thereby reducing the deterioration in the detection capability, and enhancing a continuity of the automated driving mode.

(B) Changing the setting of the inter-vehicle distance is, for example, a control to increase the target value of the inter-vehicle distance larger than an original value. The original value of the inter-vehicle distance is a value manually set by the user or automatically set by the system according to the target speed. Changing the target value of the inter-vehicle distance is implemented in cooperation with the ACC unit G61. An amount of increase in the target value of the inter-vehicle distance relative to the original value may be, for example, 25 m or 50 m. The amount of increase in the target value of the inter-vehicle distance may be determined using a concept of inter-vehicle time. That is, the higher the target value of the travel speed, the larger the amount of increase in the target value of the inter-vehicle distance may be set. The target value of the inter-vehicle distance may be changed in four stages. Increasing the target value of the inter-vehicle distance may be increasing the target value by one stage. By increasing the target value of the inter-vehicle distance, it is possible to extend the time available for evacuation control in emergency situations, such as accidents involving the preceding vehicle. As a result, the safety can be further enhanced. The original value of the inter-vehicle distance is a value that is applied when the driving environment is good, in other words, when the detection capability remains above the required level. The original value may be called a basic value or normal value.

In another embodiment, (B)changing the setting of the inter-vehicle distance may be a control to decrease the target value of the inter-vehicle distance smaller than the original value. An amount of decrease in the target value of the inter-vehicle distance relative to the original value may be, for example, 25 m or 50 m. The amount of decrease in the target value of the inter-vehicle distance may be dynamically determined, such that the amount of decrease in the target value of the inter-vehicle distance reduces with increase in the target value of the travel speed. When the target value of the inter-vehicle distance becomes smaller, the front camera 11 can more easily recognize the preceding vehicle. In other words, it becomes difficult to lose sight of the preceding vehicle. Thus, the automated driving ECU 30 more easily keeps the subject vehicle following the preceding vehicle. (B) Changing the setting of the inter-vehicle distance may be executed only when the system recognizes the preceding vehicle.

(C) Starting the parallel running indicates a start of control to adjust the traveling speed such that the subject vehicle travels parallel to another vehicle traveling in a lane adjacent to the ego-lane. According to the parallel running, the automated driving ECU 30 can more easily determine the traveling position in a width direction of the road with reference to the other vehicle, and more easily keep the ego-lane. In other words, a risk the subject vehicle deviates from the ego-lane can be reduced. The other vehicle targeted in the parallel running may be a vehicle traveling in a right lane for the subject vehicle. In left-hand traffic areas, a right-hand lane is likely to be a passing lane. If the subject vehicle runs alongside a vehicle on the left side of the road, the subject vehicle may impede the flow of traffic. When the automated driving ECU 30 detects that the other vehicle targeted in the parallel running activates its direction indicators by image recognition or inter-vehicle communication, the automated driving ECU 30 may cancel the parallel running.

A state in which the subject vehicle is running alongside the other vehicle is not limited to a state in which the subject vehicle and the other vehicle are traveling side by side. A state in which the subject vehicle is traveling diagonally behind the other vehicle by 5 m to 20 m at the same speed may also be included in the parallel running. If the subject vehicle is positioned right next to the other vehicle, the occupants of the other vehicle may feel uncomfortable. In addition, an area right next to the other vehicle includes an area that the driver of the other vehicle cannot see using the side mirror, so the area right next to the other vehicle is not a good visibility position for the driver of the other vehicle. Under such circumstances, the traveling position of the subject vehicle in the parallel running may be a position a predetermined amount further back from a position right next to the other vehicle in the parallel running.

(D) Adjusting traveling position in the with direction indicates adjusting the traveling position in the width direction of the road, more specifically, changing lanes toward the first lane. When the subject vehicle is traveling in the first lane, the outside-monitoring sensor is more likely to detect the road edge. The road edge can be determined by steps, guardrails, sidewalls, etc. The road edge has a three-dimensional structure unlike the lane marking. Therefore, the road edge is easily detected by various sensors such as the millimeter wave radar 12. In other words, even in situations where the automated driving ECU 30 has difficulty recognizing the lane marking, the automated driving ECU 30 can still recognize a position of the road edge easily. When the automated driving ECU 30 can recognize the position of the road edge, it will be easier to identify a shape of the road and the position of the subject vehicle in the width direction of the road. As a result, a risk the subject vehicle deviates from the ego-lane can be reduced. Furthermore, a risk of interruption of automated driving can be reduced.

The temporary control unit G62 does not need to perform all of the controls (A), (B), (C), and (D). The temporary control unit G62 may selectively plan and execute only some of them. For example, the temporary control unit G62 may carry out (C) or (D) only when the preceding vehicle does not exist, in other words, only when the automated driving ECU 30 cannot perform a control of following the preceding vehicle. When the preceding vehicle exists, the temporary control unit G62 may execute (B) in preference to (C). The temporary control unit G62 may select a temporary control to perform from among several candidates described above depending on the surrounding environment and/or the deterioration factor.

The automated driving ECU 30 executes step S108 as a process subsequent to step S107. In step S108, the notification processing unit G8 notifies the user of the start of the temporary control by image display or the like. In other words, the notification processing unit G8 reports to the user after the fact that the temporary control has started. The report of the start of the temporary control to the user may be omitted. This is because frequent notification may be bothersome to the user when the user is performing the second task. From a similar point of view, the notification processing unit G8 may notify the start of the temporary control by only displaying an image without outputting a voice message or notification sound. The image for notifying the start of the temporary control may include information outlining the temporary control being performed. While the automated driving ECU 30 is executing the temporary control, the HCU 20 may display an icon image on the HUD 18A indicating that the temporary control is being executed, based on an instruction from the automated driving ECU 30.

As an example, the automated driving ECU 30 may be configured to start the temporary control when a detection capability of any one of the multiple outside-monitoring sensors predicted to fall below the required level. Of course, a condition for initiating the temporary control is not limited to this. The automated driving ECU 30 may be configured to perform the temporary control only when the detection capability of a particular outside-monitoring sensor among multiple outside-monitoring sensors is predicted to fall below the required level.

The automated driving ECU 30 may also change a content of the temporary control to be performed depending on the sensor with deteriorated detection capability. For example, the automated driving ECU 30 may perform different temporary controls when the detection capability of the front camera 11 is deteriorated compared to when that of the millimeter wave radar 12 is deteriorated. Specifically, when the detection capability of the front camera 11 is deteriorated, the automated driving ECU 30 changes the settings of the inter-vehicle distance without changing the target value of the traveling speed in ACC. On the other hand, the automated driving ECU 30 reduces the target value of the traveling speed in ACC by a predetermined amount when the detection capability of the millimeter wave radar 12 is deteriorated. As long as the millimeter wave radar 12 is working properly, the distance and relative speed of the preceding vehicle can be detected accurately. On the other hand, when the millimeter wave radar 12 malfunctions, the automated driving ECU 30 may have more difficulty performing fine-tuned speed adjustment in response to the behavior of the preceding vehicle. According to the configuration in which the traveling speed is reduced by a predetermined amount in response to the deterioration in the detection capability of the millimeter wave radar 12, a time period available for dealing with an unexpected event such as an accident involving the preceding vehicle can be increased, thereby enhancing safety.

In addition, a specific content of (B) may be changed according to whether the surrounding environment is congested. When the surrounding environment is congested, the automated driving ECU 30 performs a control to shorten the target value of the inter-vehicle distance by a predetermined amount as the temporary control of (B). On the other hand, when the surrounding environment is not congested, the automated driving ECU 30 performs a control to lengthen the target value of the inter-vehicle distance by a predetermined amount as the temporary control of (B). When the target value of the inter-vehicle distance is set to a relatively small value during traffic congestion, the automated driving ECU 30 can more accurately detect a behavior of the preceding vehicle. When the vehicle is not in a traffic congestion, in other words the subject vehicle is traveling at a speed above a certain value, the automated driving ECU 30 can more safety respond to an emergency braking of the preceding vehicle by setting the target value of the inter-vehicle distance longer than the original value. In a situation where the target value of the inter-vehicle distance has been changed from the original value responding to the deterioration in the detection capability, the temporary control unit G62 may returns the target value to the original value when the detection capability recovers above the required level.

<Effect of Above Configuration>

In the configuration described above, when the detection capability of the outside-monitoring sensor is likely to fall below the required level for continuing automated driving, the automated driving ECU 30 starts the temporary control for improving safety or ease of object recognition in advance. According to this configuration, it is expected to prevent the detection capability of the outside-monitoring sensor from falling below the required level, or to extend a time remaining until the detection capability actually falls below the required level. As a result, a frequency of interruptions in the automated driving mode and a risk of deterioration in the user's convenience can be reduced.

While one embodiment of the present disclosure has been described above, the present disclosure is not limited to the embodiment described above, and various modifications to be described below are included in the technical scope of the present disclosure and may be implemented by various modifications within a scope not departing from the spirit of the present disclosure, in addition to the modifications to be described below. For example, various supplements and/or modifications to be described below can be implemented in combination as appropriate within a scope that does not cause technical inconsistency. The members having the same functions as described above are denoted by the same reference numerals, and the description of the same members will be omitted. Further, when only a part of the configuration is mentioned, the above description can be applied to the other parts.

The contents of the temporary control are not limited to the examples described above. For example, the temporary control unit G62 may perform a control (i.e., setting change) to reduce the target value of the traveling speed during automated driving by a predetermined amount from an original value, as a temporary control (E). The original value of the traveling speed is set by the user or the system.

In addition, the temporary control unit G62 may perform a handover request as the temporary control (F). The handover request corresponds to requesting the user or the operator to take over the driving operation in cooperation with the HMI system 2. The handover request also corresponds to a notification in which the automated driving ECU 30 requests the user to return to driving operation.

In addition, the temporary control unit G62 may perform a standby request as a temporary control (G). The standby request is a process for requesting the user to start preparations for the takeover. The standby request may be a process in which the automated driving ECU 30 requests the user to start forward monitoring, etc. The standby request may be interpreted as a less urgent request than the handover request. According to the configuration in which the automated driving ECU 30 perform the standby request, the user can prepare for the takeover at a good stopping point in the second task. By outputting the standby request before the handover request, a possibility of the user resuming driving operation while the second task is halfway through can be reduced. Therefore, the risk of deterioration of user convenience can be reduced.

The user is less likely to notice an image display on the HUD 18A or the meter display 18B during the automated driving mode. Therefore, the handover request may include not only displaying a message image requesting the takeover on the HUD 18A, but also outputting a voice message with similar content. On the other hand, the standby request may be a process of displaying a message image requesting to start preparations of the takeover on the HUD 18A along with outputting a predetermined notification sound. Since the standby request is less urgent, an output of a voice message requesting to start preparations for the takeover may be omitted in the standby request.

The automated driving ECU 30 may sequentially perform multiple temporary controls. For example, the automated driving ECU 30 may perform temporary controls (G) and (F) in this order after starting any one or more of temporary controls (A) to (E). The automated driving ECU 30 can extend a duration of the automated driving mode by performing any of temporary controls (A) to (E) before requesting the takeover. Therefore, a possibility of suspension of the second task can be reduced. Also, the user convenience can be improved because the remaining time until the takeover becomes longer.

The automated driving ECU 30 may be configured to perform only one of the multiple temporary controls described above. For example, the automated driving ECU 30 may be configured to perform (F) or (G) without executing any of (A) to (E), when the detection capability is predicted to fall below the required level during the automated driving mode.

In addition, the temporary control unit G62 may perform a following light control in a situation where the external illumination is below the automatic light threshold during the automated driving mode and the user is not looking ahead of the subject vehicle. In the above situation, the automated driving ECU 30 may have the lighting device 151 emit the low beams instead of the high beams regardless of oncoming or preceding vehicle, as long as the detection capability of the outside-monitoring sensor satisfies the required level even with the low-beams. When the user is not monitoring the surroundings and the detection capability of the outside-monitoring sensor is good, there is little need to emit the high beams and an emission of the high beams could be a waste of power. In addition, the emission of the high beams may dazzle surrounding pedestrians and the like. The above configuration is expected to reduce a power consumption and improve coordination with surrounding traffic. The automated driving ECU 30 may identify whether the user is looking ahead of the subject vehicle based on the output signal of DSM 17. The automated driving ECU 30 may determine whether the detection capability of the outside-monitoring sensor satisfies the required level even with the low beams by emitting the low beams for several seconds and evaluating the detection capability during that time.

The above discloses a configuration in which the automated driving ECU 30 initiates the temporary control at a timing when the capability evaluation unit G5 determines that the detection capability of a certain outside-monitoring sensor falls below the required level within the prediction time period from the present time, but the timing of an initiation of the temporary control is not limited to the above. A time lag may be provided between the determination that the detection capability of the outside-monitoring sensor falls below the required level and the initiation of the temporary control. The temporary control may be initiated before an estimated deterioration time, which is a time at which the detection capability is predicted to fall below the required level. For example, when the prediction time period is 1 minute, the temporary control may be initiated 15 seconds before the estimated deterioration time. The timing of the actual initiation of the temporary control may be varied according to the content of the temporary control to be performed. For example, a control of changing the setting of the inter-vehicle distance, reducing the traveling speed, or turning on the headlights may be started at the timing when the capability evaluation unit G5 determines that the detection capability of a certain outside-monitoring sensor falls below the required level within the prediction time period. On the other hand, a control of turning on the fog lamps may be started one minute before the estimated deterioration time. In some regions, turning on the fog lamps in a good environment may not be allowed as a traffic rule. The good environment is, for example, no fog area. In contrast, an area within one minute from the dense fog area may be a bad environment. Therefore, turning on the fog lamps one minute before the estimated deterioration time is expected to be a control that conforms to the traffic rule.

<Additional Notes>

The device such as the automated driving ECU 30, the system, and the method therefor which have been described in the present disclosure may be also realized by a dedicated computer which constitutes a processor programmed to execute one or more functions concretized by computer programs. Also, the device and the method described in the present disclosure may be also implemented by a dedicated hardware logic circuit. Further, the device and the method described in the present disclosure may be implemented by one or more dedicated computers configured by a combination of a processor that executes a computer program and one or more hardware logic circuits. The computer program may be stored in a computer-readable non-transitory tangible recording medium as an instruction to be executed by the computer. Some or all of the functions of the automated driving ECU 30 may be configured as hardware. A configuration in which a certain function is implemented by hardware includes a configuration in which the function is implemented by use of one or more ICs or the like. The automated driving ECU 30 may be implemented by using an MPU, a GPU, or a data flow processor (DFP) instead of the CPU. The automated driving ECU 30 may be realized by combining multiple types of calculation processing devices such as a CPU, an MPU, and a GPU. The automated driving ECU 30 may be provided by a system-on-chip (SoC). The automated driving ECU 30 may be implemented by using a field-programmable gate array (FPGA) or an application specific integrated circuit (ASIC). Various programs may be stored in a non-transitory tangible storage medium. As a program storage medium, various storage media such as Hard-disk Drive (HDD), Solid State Drive (SSD), flash memory, and Secure Digital (SD) card can be adopted.

The multiple functions of one component in the above embodiments may be implemented by multiple components, or a function of one component may be implemented by multiple components. Multiple functions of multiple elements may be implemented by one element, or one function implemented by multiple elements may be implemented by one element. A part of the configuration of the above embodiment may be omitted as appropriate. The scope of the present disclosure also includes programs for causing a computer to function as the automated driving ECU 30, non-transitory tangible storage mediums such as semiconductor memories which store these programs, and other aspects.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A vehicle control device configured to execute an automated driving of a vehicle, the automated driving being a control for autonomously driving the vehicle based on an output signal of an outside-monitoring sensor that detects an object existing around the vehicle, the vehicle control device comprising a processor configured to:
predict whether a detection capability of the outside-monitoring sensor falls below a required level within a prediction time period based on a history of the output signal of the outside-monitoring sensor or dynamic map data related to a road section through which the vehicle is scheduled to pass, the required level corresponding to a performance quality of the outside-monitoring sensor required to continue the automated driving, the prediction time period being a predetermined time period from a current time, the history of the output signal being a history for a predetermined time period immediately before the current time, the dynamic map data being data acquired via a wireless communication from an external device; and
start a predetermined temporary control during the automated driving based on a fact that the detection capability is predicted to fall below the required level within the prediction time period.

2. The vehicle control device according to claim 1, further comprising
a communication interface for communicating with a lighting control device that automatically turns on a headlight of the vehicle based on a fact that an external illuminance detected by an illuminance sensor installed in the vehicle is less than a predetermined lighting threshold, wherein
the processor is further configured to, in the temporary control, turn on the headlight even when the external illuminance is at or above the lighting threshold.

3. The vehicle control device according to claim 1, wherein
the processor is further configured to:
identify a deterioration factor when the detection capability is predicted to fall below the required level within the prediction time period, the deterioration factor being a factor of deterioration in the detection capability; and
change a content of the temporary control according to the deterioration factor.

4. The vehicle control device according to claim 3, wherein
the processor is further configured to, in the temporary control, turn on a fog lamp before the vehicle enters the road section with fog or dust when the fog or dust is identified as the deterioration factor.

5. The vehicle control device according to claim 1, further comprising
a communication interface for communicating with a lighting control device that automatically emits a high beam or a low beam from a headlight when an external illuminance detected by an illuminance sensor installed in the vehicle is less than a predetermined lighting threshold, wherein
the processor is further configured to:
obtain information indicating a gaze direction of a user seated in a driver's seat, the gaze direction of the user being a direction determined by analyzing images captured by a camera installed in a vehicle cabin; and
output a command signal to the lighting control device for emitting the low beam regardless of oncoming traffic when the automated driving is being executed at night, the detection capability exceeds the required level even with the low beam, and the gaze direction is not toward ahead of the vehicle.

6. The vehicle control device according to claim 1, further comprising
a communication interface for communicating with a lighting control device that controls a lighting mode of a headlight configured to emit a high beam and a low beam, wherein
the headlight is configured to emit a semi-high beam that is longer in illuminating range than the low beam and shorter in illuminating range than the high beam, and
the processor is further configured to, in the temporary control, output a command signal to the lighting control device for emitting the semi-high beam.

7. The vehicle control device according to claim 1, wherein
the processor is further configured to:
execute a vehicle following control that causes the vehicle to follow a preceding vehicle keeping a predetermined inter-vehicle distance; and
set a target value of the inter-vehicle distance to be smaller than an original value of the inter-vehicle distance in the temporary control, the original value being a value used for a case where the detection capability is predicted to be at or above the required level.

8. The vehicle control device according to claim 1, wherein
the processor is further configured to:
execute a vehicle following control that causes the vehicle to follow a preceding vehicle keeping a predetermined inter-vehicle distance; and
set a target value of the inter-vehicle distance to be larger than an original value of the inter-vehicle distance in the temporary control, the original value being a value used for a case where the detection capability is predicted to be at or above the required level.

9. The vehicle control device according to claim 1, wherein
the processor is further configured to:
execute a vehicle following control that causes the vehicle to follow a preceding vehicle keeping a predetermined inter-vehicle distance;
set a target value of the inter-vehicle distance to be smaller by a predetermined amount than an original value of the inter-vehicle distance in the temporary control when the vehicle is in a congested road section, the original value being a value set manually or set automatically according to a traveling speed of the vehicle; and
set the target value of the inter-vehicle distance to be larger by a predetermined amount than the original value in the temporary control when the vehicle is not in a congested road section.

10. The vehicle control device according to claim 7, wherein
the processor is configured to return the target value of the inter-vehicle distance to the original value in response to a recovery of the detection capability at or above the required level in a situation where the target value of the inter-vehicle distance has been changed from the original value based on a prediction of deterioration in the detection capability.

11. The vehicle control device according to claim 1, wherein
the processor is configured to, in the temporary control, cause the vehicle to run alongside another vehicle traveling in an adjacent lane of the vehicle, or change a traveling lane of the vehicle to a lane adjacent to a road edge.

12. The vehicle control device according to claim 1, wherein
the processor is configured to, in the temporary control, output a notification requesting a user seated in a driver's seat to take over a driving operation from the vehicle control device or a notification requesting the user to start preparation for taking over the driving operation from the vehicle control device.

13. The vehicle control device according to claim 11, wherein
the processor is configured to output a notification requesting a user seated in a driver's seat to take over a driving operation after start of the temporary control.

14. The vehicle control device according to claim 1, wherein
the processor is configured to, in the temporary control, change lanes to a lane adjacent to a road edge and continue the automated driving until the detection capability actually falls below the required level.

15. A vehicle control method for a vehicle configured to execute an automated driving based on an output signal of an outside-monitoring sensor that detects an object existing around the vehicle, the vehicle control method being executed by at least one processor, the vehicle control method comprising:
predicting whether a detection capability of the outside-monitoring sensor falls below a required level within a prediction time period based on a history of the output signal of the outside-monitoring sensor or dynamic map data related to a road section through which the vehicle is scheduled to pass, the required level corresponding to a performance quality of the outside-monitoring sensor required to continue the automated driving, the prediction time period being a predetermined time period from a current time, the history of the output signal being a history for a predetermined time period immediately before the current time, the dynamic map data being data acquired via a wireless communication from an external device; and
starting a predetermined temporary control during the automated driving based on a fact that the detection capability is predicted to fall below the required level within the prediction time period.
